(19) United States
(12) Patent Application Publication
(10) Pub. No.: US 2025/0385619 A1
(43) Pub. Date: Dec. 18, 2025

(54) DC/AC CIRCUIT AND INVERTER DEVICE

(71) Applicant: HOYMILES POWER ELECTRONICS INC., Hangzhou (CN)

(72) Inventors: Yuxi WANG, Hangzhou (CN); Benben ZHANG, Hangzhou (CN); Junxiong WU, Hangzhou (CN); Qingfeng LV, Hangzhou (CN); Bingwen WENG, Hangzhou (CN)

(21) Appl. No.: 19/302,784

(22) Filed: Aug. 18, 2025

Related U.S. Application Data
(63) Continuation of application No. PCT/CN2024/074411, filed on Jan. 29, 2024.

(30) Foreign Application Priority Data
Mar. 14, 2023 (CN) 202310267046.9

(51) Int. Cl. H02M 7/539

(52) U.S. Cl. CPC H02M 7/539

(57) ABSTRACT

A DC/AC circuit and an inverter device are provided. The DC/AC circuit includes: an inverter unit, including a first bridge arm and a second bridge arm which are connected between positive and negative DC buses; a freewheeling unit, including a first freewheeling circuit connected between a midpoint of the first bridge arm and a midpoint of the positive and negative DC buses, and a second freewheeling circuit connected between a midpoint of the second bridge arm and the midpoint of the positive and negative DC buses; and a first switching unit, a fixed terminal and a first switching terminal of the first switching unit being connected in series to one of the first freewheeling circuit and the second freewheeling circuit, and a second switching terminal of the first switching unit being connected to the other one of the first freewheeling circuit and the second freewheeling circuit to form a freewheeling loop.

### CROSS-REFERENCE TO RELATED APPLICATIONS

This application is a continuation of international patent application No. PCT/CN2024/074411, filed on Jan. 29, 2024, which itself claims priority to Chinese patent application No. 202310267046.9, filed on Mar. 14, 2023, titled “DC/AC CIRCUIT CONTROL METHOD AND DC/AC CIRCUIT”. The contents of the above identified applications are hereby incorporated herein in their entireties by reference.

### TECHNICAL FIELD

The present disclosure generally relates to the field of inversion, and in particular, to a DC/AC circuit and an inverter device.

### BACKGROUND

ADC (Direct Current)/AC (Alternating Current) circuit is widely applied in power conversion scenarios of grid interconnection such as renewable energy generation, energy storage systems, and electric vehicle charging.

In a phase splitting grid, a related DC/AC circuit splits an output voltage of the DC/AC circuit by a power frequency isolation transformer or an autotransformer to obtain two types of voltages: 120V and 240V. However, the DC/AC circuit can only output a voltage level of 120V or 240V in a single phase, and has disadvantages of large volume, high cost, and large loss.

### SUMMARY

According to various embodiments of the present disclosure, a DC/AC circuit and an inverter device are provided.

In a first aspect, a DC/AC circuit is provided in the present disclosure. The DC/AC circuit includes an inverter unit, a freewheeling unit, and a first switching unit. The inverter unit includes a first bridge arm and a second bridge arm which are connected between positive and negative DC buses and configured to invert a direct current output by the positive and negative DC buses to an alternating current. The freewheeling unit includes a first freewheeling circuit connected between a midpoint of the first bridge arm and a midpoint of the positive and negative DC buses, and a second freewheeling circuit connected between a midpoint of the second bridge arm and the midpoint of the positive and negative DC buses. A fixed terminal and a first switching terminal of the first switching unit are connected in a branch at which one of the first freewheeling circuit and the second freewheeling circuit is located, and a second switching terminal of the first switching unit is connected to the other one of the first freewheeling circuit and the second freewheeling circuit to form a freewheeling loop.

In an embodiment, when the fixed terminal of the first switching unit is in communication with the first switching terminal of the first switching unit, the DC/AC circuit outputs the alternating current in a phase splitting operating mode. When the fixed terminal of the first switching unit is in communication with the second switching terminal of the first switching unit, the DC/AC circuit outputs the alternating current in a single-phase operating mode.

In an embodiment, the fixed terminal and the first switching terminal of the first switching unit are connected in series between the midpoint of the positive and negative DC buses and one of the first freewheeling circuit and the second freewheeling circuit, and the second switching terminal of the first switching unit is connected to the other one of the first freewheeling circuit and the second freewheeling circuit.

In an embodiment, the first freewheeling circuit includes at least two switching elements connected in series, and the second freewheeling circuit includes at least two switching elements connected in series. The fixed terminal and the first switching terminal of the first switching unit are connected in series between two switching elements, which are in one of the first freewheeling circuit and the second freewheeling circuit, and the second switching terminal of the first switching unit is connected to a midpoint of two switching elements, which are in the other one of the first freewheeling circuit and the second freewheeling circuit.

In an embodiment, the first freewheeling circuit includes a first switching element and a second switching element connected in series, the second switching element is connected to the midpoint of the first bridge arm, the second freewheeling circuit includes a third switching element and a fourth switching element connected in series, and the fourth switching element is connected to the midpoint of the second bridge arm.

In an embodiment, the fixed terminal of the first switching unit is connected to the first switching element or the third switching element, and the first switching terminal of the first switching unit is connected to the midpoint of the positive and negative DC buses.

In an embodiment, the fixed terminal of the first switching unit is connected to the fourth switching element, the first switching terminal of the first switching unit is connected to the third switching element, and the second switching terminal of the first switching unit is connected to a midpoint between the first switching element and the second switching element. Alternatively, the fixed terminal of the first switching unit is connected to the second switching element, the first switching terminal of the first switching unit is connected to the first switching element, and the second switching terminal of the first switching unit is connected to a midpoint between the third switching element and the fourth switching element.

In an embodiment, the DC/AC circuit further includes a second switching unit and a third switching unit which are connected to an output terminal of the inverter unit, and the second switching unit and the third switching unit are configured to control switch between grid interconnection and grid off.

In an embodiment, the DC/AC circuit further includes a fourth switching unit connected between the midpoint of the positive and negative DC buses and a null line terminal, when the DC/AC circuit is in a phase splitting operating mode, the fourth switching unit is in a turn-on state, and when the DC/AC circuit is in a single-phase operating mode, the fourth switching unit is in a turn-off state.

In an embodiment, the DC/AC circuit further includes a first filter unit connected to an output terminal of the inverter unit, and the first filter unit is connected to the midpoint of the positive and negative DC buses.

In an embodiment, the DC/AC circuit further includes a second filter unit connected between the positive and negative DC buses, and the second filter unit includes a third capacitor connected between the positive DC bus and the midpoint of the positive and negative DC buses, and a fourth capacitor connected between the negative DC bus and the midpoint of the positive and negative DC buses.

In a second aspect, an inverter device is provided in the present disclosure, including a control unit and the DC/AC circuit in the first aspect, and the control unit is configured to control the DC/AC circuit.

Details of one or more embodiments of the present disclosure are proposed in the following accompanying drawings and descriptions, so that other features, objects, and advantages of the present disclosure are more easily understood.

### BRIEF DESCRIPTION OF THE DRAWINGS

To describe the technical solutions in the embodiments of the present disclosure or the related technologies more clearly, the following briefly describes the accompanying drawings required for describing the embodiments or the related technologies. Apparently, the accompanying drawings in the following description show merely the embodiments of the present disclosure, and one skilled in the art may still derive other drawings from the disclosed accompanying drawings without creative efforts.

FIG. 1 is a schematic diagram of a DC/AC circuit in a first embodiment of the present disclosure.

FIG. 2 is a specific schematic diagram of a DC/AC circuit in an embodiment of the present disclosure.

FIG. 3 is a specific schematic diagram of a DC/AC circuit in another embodiment of the present disclosure.

FIG. 4 is a specific schematic diagram of a DC/AC circuit in another embodiment of the present disclosure.

FIG. 5 is a schematic diagram of a DC/AC circuit in a second embodiment of the present disclosure.

FIG. 6 is a schematic diagram of a DC/AC circuit in a third embodiment of the present disclosure.

FIG. 7 is a schematic diagram of a DC/AC circuit in a fourth embodiment of the present disclosure.

FIG. 8 is a schematic diagram of a circuit structure of a DC/AC circuit in a first exemplary embodiment of the present disclosure.

FIG. 9 is a schematic diagram of a state in which a DC/AC circuit is in a grid-off phase splitting operating mode in the first exemplary embodiment of the present disclosure.

FIG. 10 is a schematic diagram of a wave transmission time sequence of a switching element when a DC/AC circuit is in a grid-off phase splitting operating mode in the first exemplary embodiment of the present disclosure.

FIG. 11 is a schematic diagram of a state in which a DC/AC circuit is in a grid-off single-phase operating mode in the first exemplary embodiment of the present disclosure.

FIG. 12 is a schematic diagram of a state in which a DC/AC circuit is in a grid-interconnection single-phase operating mode in the first exemplary embodiment of the present disclosure.

FIG. 13 is a schematic diagram of a wave transmission time sequence of a switching element when a DC/AC circuit is in a grid-interconnection single-phase operating mode in the first exemplary embodiment of the present disclosure.

FIG. 14 is a schematic diagram of a circuit structure of a DC/AC circuit in a second exemplary embodiment of the present disclosure.

FIG. 15 is a schematic diagram of a circuit structure of a DC/AC circuit in a third exemplary embodiment of the present disclosure.

### DETAILED DESCRIPTION OF THE EMBODIMENT

The following clearly and completely describes the technical solutions in the embodiments of the present disclosure with reference to the accompanying drawings in the embodiments of the present disclosure. Apparently, the described embodiments are merely some rather than all of the embodiments of the present disclosure. Based on the embodiments of the present disclosure, all other embodiments obtained by one skilled in the art without creative efforts fall within the protection scope of the present disclosure.

The reference to “embodiments” in the present disclosure means that specific features, structures, or characteristics described in conjunction with the embodiments may be included in at least one embodiment of the present disclosure. A phrase appearing in various positions in the description does not necessarily refer to the same embodiment, nor is it an independent or alternative embodiment that is mutually exclusive with other embodiments. One skilled in the art will explicitly and implicitly understand that the embodiments described in the present disclosure can be combined with other embodiments without conflict.

Unless otherwise defined, the technical or scientific terms referred to in the present disclosure shall have the usual meanings understood by one skilled in the art to which the present disclosure belongs. Words in the present disclosure such as “one”, “a”, “a kind of”, and/or “the” do not specifically refer to singular, but may also include plural. The terms “include”, “contain”, “have” and any variations thereof referred to in the present disclosure are intended to cover non-exclusive inclusions. For example, a process, a method, a system, a product, or an apparatus that includes a series of steps or modules (units) is not limited to the listed steps or units, but may also include steps or units that are not listed, or may also include other steps or units inherent to the process, the method, the system, the product, or the apparatus. The terms “junction”, “connection”, “coupling” and similar terms referred to in the present disclosure are not limited to physical or mechanical connections, but may include electrical connections, whether direct or indirect. The term “a plurality of” referred to in the present disclosure means greater than or equal to two. “And/or” describes an association relationship of associated objects, indicating that there can be three types of relationships. For example, “A and/or B” can represent: A exists alone, A and B exist simultaneously, and B exists alone. The terms “first”, “second”, “third”, etc. mentioned in the present disclosure are only used to distinguish similar objects and do not represent a specific ranking for the objects.

In the present disclosure, unless otherwise stated or implied, the phrase “at least one of” followed with a list of items refers to any combination of those items, including single members. Both “at least one of: a, b, or c” and “at least one of: a, b, and c” are intended to cover: a, b, c, a combination of a and b, a combination of a and c, a combination of b and c, and a combination of a, b, and c.

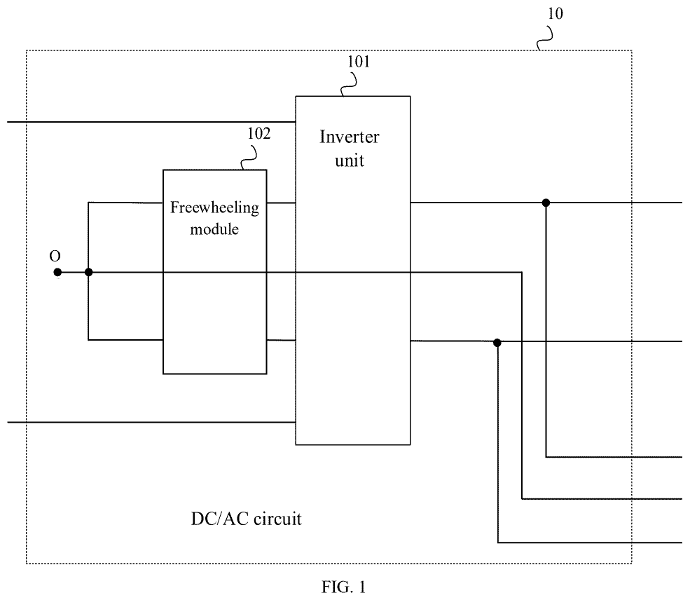

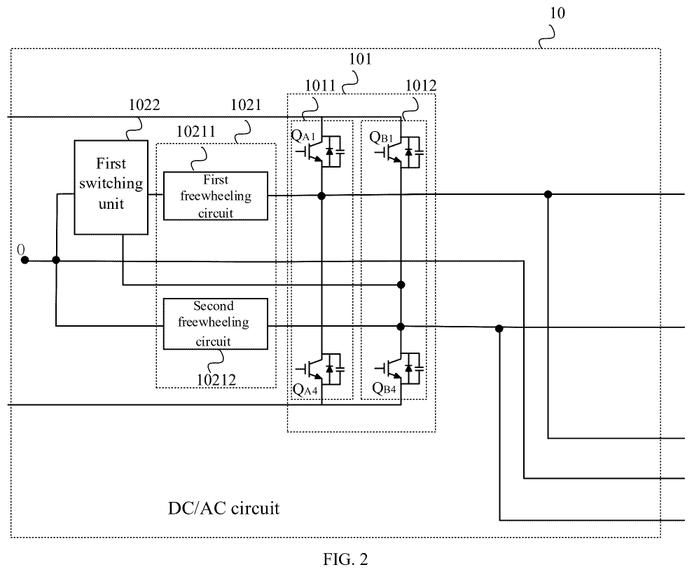

FIG. 1 is a schematic diagram of a DC/AC circuit in an embodiment of the present disclosure. The DC/AC circuit 10 includes an inverter unit 101 and a freewheeling module 102. Specifically, referring to FIG. 2 to FIG. 4, the inverter unit 101 includes a first bridge arm 1011 and a second bridge arm 1012 which are connected between positive and negative DC buses and configured to invert a direct current output by the positive and negative DC buses to an alternating current. The freewheeling module 102 includes a freewheeling unit 1021 and a first switching unit 1022. The freewheeling unit 1021 includes a first freewheeling circuit 10211 connected between a midpoint of the first bridge arm 1011 and a midpoint O of the positive and negative DC buses (i.e., a middle electrical connecting point between the positive DC bus and the negative DC bus), and a second freewheeling circuit 10212 connected between a midpoint of the second bridge arm 1012 and the midpoint O of the positive and negative DC buses. A fixed terminal and a first switching terminal of the first switching unit 1022 are connected in a branch at which one of the first freewheeling circuit 10211 and the second freewheeling circuit 10212 is located, a second switching terminal of the first switching unit 1022 is connected to the other one of the first freewheeling circuit 10211 and the second freewheeling circuit 10212, and the second switching terminal of the first switching unit 1022 is connected to a midpoint of a corresponding bridge arm in the first bridge arm 1011 and the second bridge arm 1012 to form a freewheeling loop.

In an embodiment, the fixed terminal and the first switching terminal of the first switching unit may be connected in series between the midpoint of the positive and negative DC buses and one of the first freewheeling circuit and the second freewheeling circuit, and the second switching terminal of the first switching unit may be connected to the other one of the first freewheeling circuit and the second freewheeling circuit.

FIG. 2 is a specific schematic diagram of a DC/AC circuit in an embodiment of the present disclosure. In the present embodiment, the fixed terminal and the first switching terminal of the first switching unit 1022 may be connected between the first freewheeling circuit 10211 and the midpoint O of DC buses, and the second switching terminal of the first switching unit 1022 may be connected to the second freewheeling circuit 10212 and the midpoint of the second bridge arm 1012.

Specifically, the fixed terminal of the first switching unit 1022 may be connected to the first freewheeling circuit 10211, and the first switching terminal of the first switching unit 1022 may be connected to the midpoint O of DC buses.

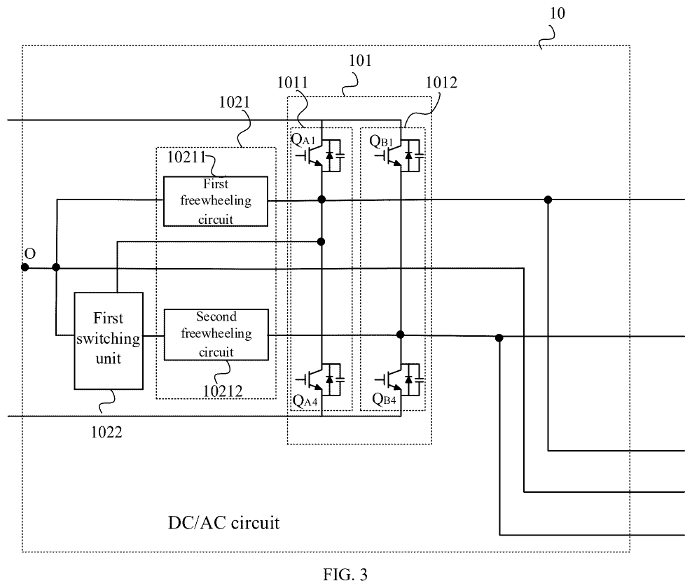

FIG. 3 is a specific schematic diagram of a DC/AC circuit in another embodiment of the present disclosure. In the present embodiment, the fixed terminal and the first switching terminal of the first switching unit 1022 may be connected between the second freewheeling circuit 10212 and the midpoint O of DC buses, and the second switching terminal of the first switching unit 1022 may be connected to the first freewheeling circuit 10211 and the midpoint of the first bridge arm 1011.

Specifically, the fixed terminal of the first switching unit 1022 may be connected to the second freewheeling circuit 10212, and the first switching terminal of the first switching unit 1022 may be connected to the midpoint O of DC buses.

In an embodiment, the first freewheeling circuit may include at least two switching elements connected in series, and the second freewheeling circuit may include at least two switching elements connected in series. The fixed terminal and the first switching terminal of the first switching unit may be connected in series between two switching elements, which are in one of the first freewheeling circuit and the second freewheeling circuit, and the second switching terminal of the first switching unit may be connected to a midpoint of two switching elements, which are in the other one of the first freewheeling circuit and the second freewheeling circuit.

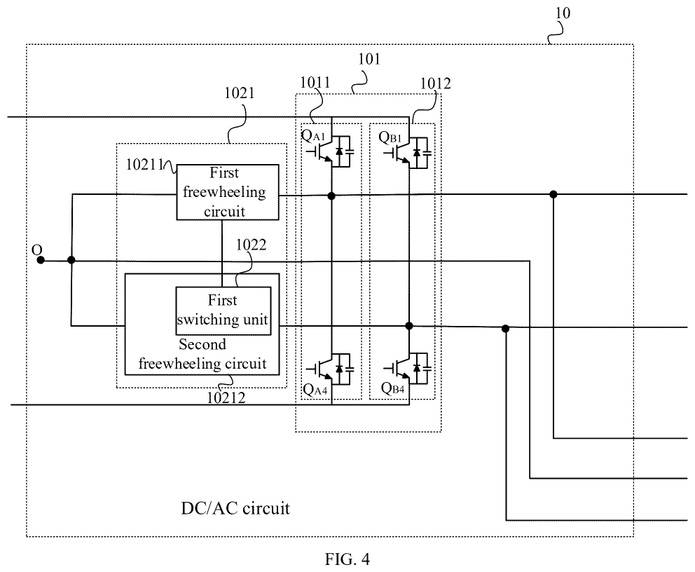

FIG. 4 is a specific schematic diagram of a DC/AC circuit in another embodiment of the present disclosure. In the present embodiment, the fixed terminal and the first switching terminal of the first switching unit 1022 may be connected in series between two switching elements of the second freewheeling circuit 10212, and the second switching terminal of the first switching unit 1022 may be connected to a midpoint of two switching elements of the first freewheeling circuit 10211.

It should be noted that the fixed terminal and the first switching terminal of the first switching unit 1022 may also be connected in series between two switching elements of the first freewheeling circuit 10211, and the second switching terminal of the first switching unit 1022 may be connected to a midpoint of two switching elements of the second freewheeling circuit 10212.

When the fixed terminal of the first switching unit 1022 is in communication with the first switching terminal of the first switching unit 1022, the inverter unit 101 may output the alternating current in a phase splitting operating mode. When the fixed terminal of the first switching unit 1022 is in communication with the second switching terminal of the first switching unit 1022, the DC/AC circuit may output the alternating current in a single-phase operating mode.

In the present embodiment, the DC/AC circuit may not need an isolation transformer, and implement outputting the alternating current in the single-phase operating mode or in the phase splitting operating mode by switching of the first switching unit 1022, thereby improving reusability and operating efficiency of the DC/AC circuit. When the DC/AC circuit is in the phase splitting operating mode, output of each phase of the DC/AC circuit may be controlled by controlling the switching elements in the DC/AC circuit. Since no isolation transformer is required, a volume, a weight, and a cost of a DC/AC system may be reduced.

Furthermore, when the DC/AC circuit is in the single-phase operating mode, the freewheeling circuit at which the first switching unit 1022 is located may be disconnected from the midpoint of the positive and negative DC buses, and an output voltage of the DC/AC circuit may not be affected by an imbalance between a voltage of the positive DC bus and a voltage of the negative DC bus, so as to avoid a problem that an output voltage is offset to overvoltage.

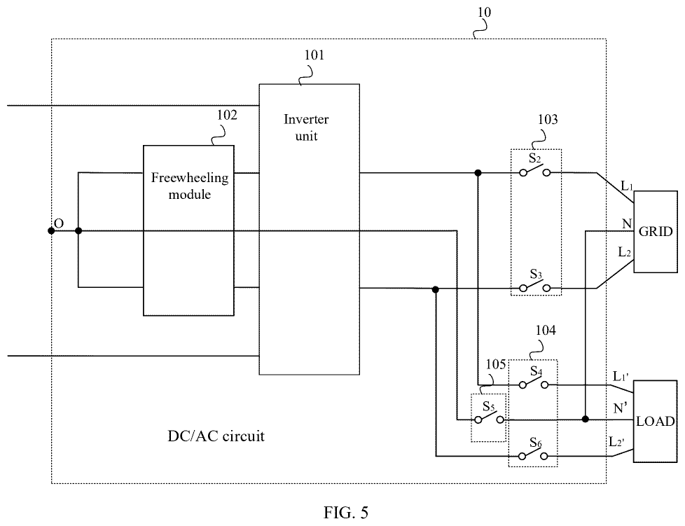

In an embodiment, referring to FIG. 5, the DC/AC circuit may further include a second switching unit 103 and a third switching unit 104. The second switching unit may be connected between an output terminal of the inverter unit 101 and a GRID, and the third switching unit 104 may be connected between an output terminal of the inverter unit 101 and a LOAD. The GRID may include a first terminal L1, a second terminal L2, and a null line terminal N, the LOAD may include a first terminal L1′, a second terminal L2′, and a null line terminal N′, and the null line terminal N may be connected to the null line terminal N′.

Grid-interconnection output or grid-off output of the DC/AC circuit may be implemented by on-off control of the second switching unit 103 and the third switching unit 104. When the output terminal of the inverter unit 101 is in communication with the GRID, the grid-interconnection output of the DC/AC circuit may be implemented. When the output terminal of the inverter unit 101 is disconnected from the GRID and the output terminal of the inverter unit 101 is in communication with the LOAD, the grid-off output of the DC/AC circuit may be implemented.

Furthermore, the DC/AC circuit may further include a fourth switching unit 105 connected between the midpoint O of the positive and negative DC buses and the null line terminal.

Specifically, the second switching unit 103 may further include a second switch S2 and a third switch S3. The third switching unit 104 may further include a fourth switch S4 and a sixth switch S6. The fourth switching unit 105 may include a fifth switch S5.

When the DC/AC circuit is in the phase splitting operating mode, the fourth switching unit 105 may be in a turn-on state. When the DC/AC circuit is in the single-phase operating mode, the fourth switching unit 105 may be in a turn-off state.

Four operating modes of the DC/AC circuit may be implemented by switching control combination of the first switching unit 1022, the second switching unit 103, the third switching unit 104, and the fourth switching unit 105, i.e., a grid-off phase splitting operating mode, a grid-off single-phase operating mode, a grid-interconnection phase splitting operating mode, and a grid-interconnection single-phase operating mode.

According to an output requirement of the DC/AC circuit, switching control may be performed on the first switching unit 1022, the second switching unit 103, the third switching unit 104, and the fourth switching unit 105, so as to control the DC/AC circuit to operate in a corresponding operating mode.

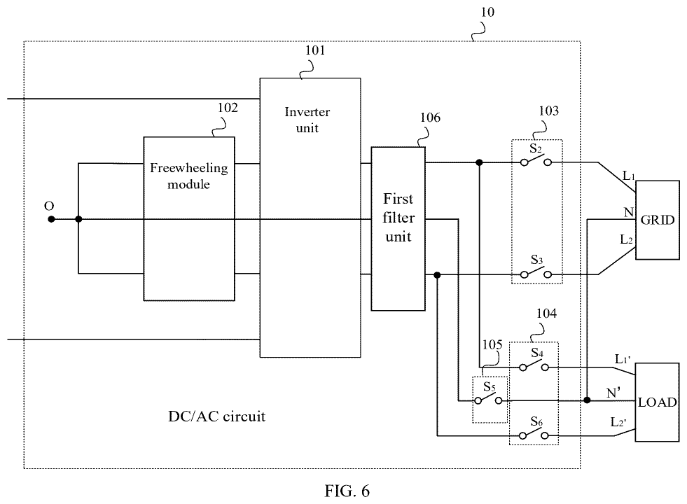

In an embodiment, referring to FIG. 6, the DC/AC circuit may further include a first filter unit 106 connected to an output terminal of the inverter unit 101, and the first filter unit 106 may be connected to the midpoint O of the positive and negative DC buses, so as to implement filter on an output signal of the inverter unit 101.

For example, the first filter unit 106 may include a filter circuit which includes a capacitor and an inductor.

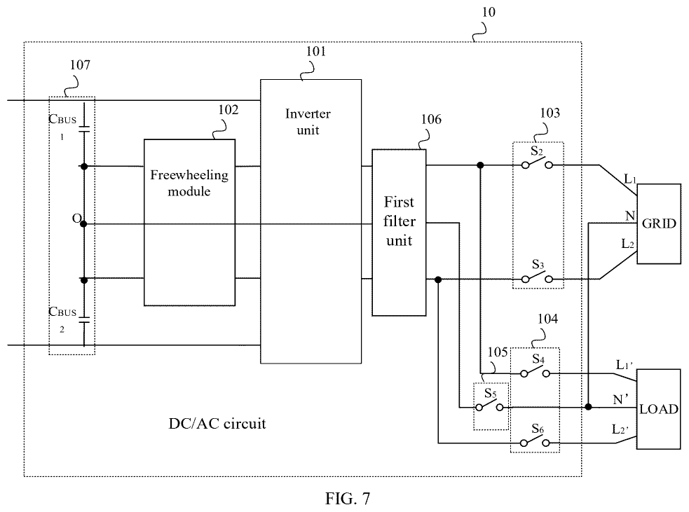

In an embodiment, referring to FIG. 7, the DC/AC circuit may further include a second filter unit 107 connected between the positive and negative DC buses, and the second filter unit 107 may include a third capacitor C_{BUS1} connected between the positive DC bus and the midpoint O of the positive and negative DC buses, and a fourth capacitor C_{BUS2} connected between the negative DC bus and the midpoint O of the positive and negative DC buses, so as to implement filtering on an input signal of the DC/AC circuit.

In a specific embodiment, the first freewheeling circuit 10211 may include a first switching element and a second switching element connected in series, the second switching element may be connected to the midpoint of the first bridge arm, the second freewheeling circuit may include a third switching element and a fourth switching element connected in series, and the fourth switching element may be connected to the midpoint of the second bridge arm.

In an alternatively embodiment, the fixed terminal of the first switching unit 1022 may be connected to the first switching element or the third switching element, and the first switching terminal of the first switching unit 1022 may be connected to the midpoint O of the positive and negative DC buses.

In an alternatively embodiment, the fixed terminal of the first switching unit 1022 may be connected to the fourth switching element, the first switching terminal of the first switching unit 1022 may be connected to the third switching element, and the second switching terminal of the first switching unit 1022 may be connected to a midpoint between the first switching element and the second switching element. Alternatively, the fixed terminal of the first switching unit 1022 may be connected to the second switching element, the first switching terminal of the first switching unit 1022 may be connected to the first switching element, and the second switching terminal of the first switching unit 1022 may be connected to a midpoint between the third switching element and the fourth switching element.

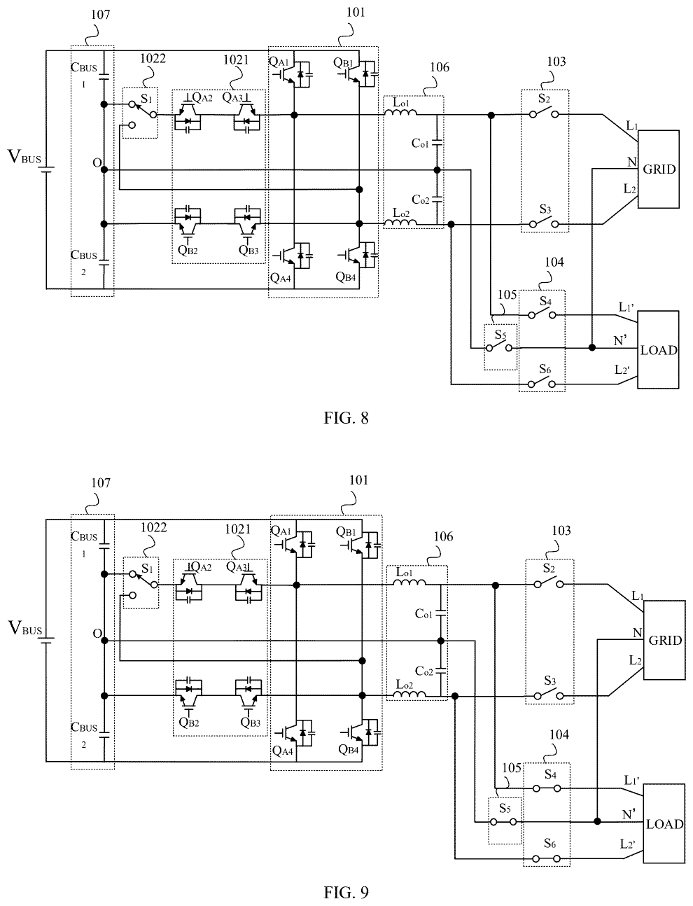

In an exemplary embodiment, referring to FIG. 8, the DC/AC circuit may include the inverter unit 101, the freewheeling unit 1021, the first switching unit 1022, the second switching unit 103, the third switching unit 104, the fourth switching unit 105, the first filter unit 106, and the second filter unit 107. The freewheeling unit 1021 includes the first freewheeling circuit and the second freewheeling circuit, the first freewheeling circuit may include the first switching element Q_{A2} and the second switching element Q_{A3}, and the second freewheeling circuit may include the third switching element Q_{B2} and the fourth switching element Q_{B3}. The inverter unit 101 includes the first bridge arm and the second bridge arm, the first bridge arm may include a fifth switching element Q_{A1} and a sixth switching element Q_{A4}, and the second bridge arm may include a seventh switching element Q_{B1} and an eighth switching element Q_{B4}. The first switching unit 1022 may include the first switch S₁. The second switching unit 103 may include the second switch S₂ and the third switch S₃. The third switching unit 104 may include the fourth switch S₄ and the sixth switch S₆. The fourth switching unit 105 may include the fifth switch S₅. The first filter unit 106 may include a first inductor Lₒ₁, a second inductor Lₒ₂, a first capacitor Cₒ₁, and a second capacitor Cₒ₂. The second filter unit 107 includes the third capacitor C_{BUS1} and the fourth capacitor C_{BUS2}.

The switching element may include any one of MOS (Metal Oxide Semiconductor), IGBT (Insulate-Gate Bipolar Transistor) or the like. In the present disclosure, it takes that the switch element is an IGBT as an example.

An emitter (source) electrode of the first switching element Q_{A2} may be connected to a fixed terminal of the first switch S₁, a collector (drain) electrode of the first switching element Q_{A2} may be connected to a collector (drain) electrode of the second switching element Q_{A3}, and an emitter (source) electrode of the second switching element Q_{A3} may be connected to the midpoint of the first bridge arm. A first switching terminal of the first switch S₁ may be connected to the midpoint O of the positive and negative DC buses, and a second switching terminal of the first switch S₁ may be connected to the midpoint of the second bridge arm. One terminal of the first inductor Lₒ₁ may be connected to the midpoint of the first bridge arm, the other terminal of the first inductor Lₒ₁ may be connected to one terminal of the first capacitor Cₒ₁, one terminal of the second switch S₂, and one terminal of the fourth switch S₄, the other terminal of the first capacitor Cₒ₁ may be connected to the midpoint O of the positive and negative DC buses, the other terminal of the second switch S₂ may be connected to the first terminal L₁ of the GRID, and the other terminal of the fourth switch S₄ may be connected to the first terminal L₁′ of the LOAD.

An emitter (source) electrode of the third switching element Q_{B2} may be connected to the midpoint O of the positive and negative DC buses, a collector (drain) electrode of the third switching element Q_{B2} may be connected to a collector (drain) electrode of the fourth switching element Q_{B3}, and an emitter (source) electrode of the fourth switching element Q_{B3} may be connected to the midpoint of the second bridge arm. One terminal of the second inductor Lₒ₂ may be connected to the midpoint of the second bridge arm, the other terminal of the second inductor Lₒ₂ may be connected to one terminal of the second capacitor Cₒ₂, one terminal of the third switch S₃, and one terminal of the sixth switch S₆, the other terminal of the second capacitor Cₒ₂ may be connected to the midpoint O of the positive and negative DC buses, the other terminal of the third switch S₃ may be connected to the second terminal L₂ of the GRID, and the other terminal of the sixth switch S₆ may be connected to the second terminal L₂′ of the LOAD. One terminal of the fifth switch S₅ may be connected to the midpoint O of the positive and negative DC buses, the other terminal of the fifth switch S₅ may be connected to the null line terminal N′ of the LOAD, and the null line terminal N′ of the LOAD may be connected to the null line terminal N of the GRID. The third capacitor C_{BUS1} may be connected between the positive DC bus and the midpoint O, and the fourth capacitor C_{BUS2} may be connected between the negative DC bus and the midpoint O.

The foregoing DC/AC circuit may have four operating modes. When the fixed terminal of the first switch S₁ is in communication with the first switching terminal, the fourth switch S₄, the fifth switch S₅, and the sixth switch S₆ are turned on, and the second switch S₂ and the third switch S₃ are turned off, the DC/AC circuit may be in the grid-off phase splitting operating mode, providing two-phase outputs (for example, two outputs with a phase difference of 180° and a voltage of 120V). When the fixed terminal of the first switch S₁ is in communication with the second switching terminal, the fourth switch S₄ and the sixth switch S₆ are turned on, and the second switch S₂, the fifth switch S₅, and the third switch S₃ are turned off, the DC/AC circuit may be in the grid-off single-phase operating mode, providing a single-phase output (for example, an output with a voltage of 240V). When the fixed terminal of the first switch S₁ is in communication with the first switching terminal, the fourth switch S₄ and the sixth switch S₆ are turned off, and the second switch S₂, the third switch S₃, and the fifth switch S₅ are turned on, the DC/AC circuit may be in the grid-interconnection phase splitting operating mode. When the fixed terminal of the first switch S₁ is in communication with the second switching terminal, the fourth switch S₄, the fifth switch S₅, and the sixth switch S₆ are turned off, and the second switch S₂ and the third switch S₃ are turned on, the DC/AC circuit may be in the grid-interconnection single-phase operating mode.

It should be noted that the first switching element Q_{A2} and the second switching element Q_{A3}, and the third switching element Q_{B2} and the fourth switching element Q_{B3} may be connected in a top-to-top manner (emitter electrodes of two switching elements are connected), or may be connected in a back-to-back manner (collector electrodes of two switching elements are connected).

FIG. 9 is a schematic diagram of a state in which a DC/AC circuit in the grid-off phase splitting operating mode in a first exemplary embodiment of the present disclosure. FIG. 10 is a schematic diagram of a wave transmission time sequence of a switching element when a DC/AC circuit in the grid-off phase splitting operating mode in the first exemplary embodiment of the present disclosure. When the DC/AC circuit is in the grid-off phase splitting operating mode, the fifth switching element Q_{A1}, the sixth switching element Q_{A4}, the seventh switching element Q_{B1}, and the eighth switching element Q_{B4} may be taken as main power switches, and the first switching element Q_{A2}, the second switching element Q_{A3}, the third switching element Q_{B2}, and the fourth switching element Q_{B3} may be in operation as freewheeling tubes.

When a voltage signal of an inverter side of the DC/AC circuit is in a positive half-cycle, drive signals of the fifth switching element Q_{A1}, the first switching element Q_{A2}, the fourth switching element Q_{B3}, and the eighth switching element Q_{B4} may be PWM (Pulse Width Modulation) signals, the second switching element Q_{A3} and the third switching element Q_{B2} may be turned on as freewheeling tubes, the first switching element Q_{A2} and the fifth switching element Q_{A1} are turned on in a complementary manner, the fourth switching element Q_{B3} and the eighth switching element Q_{B4} are turned on in a complementary manner, the second switching element Q_{A3} and the third switching element Q_{B2} may be always turned on, and the sixth switching element Q_{A4} and the seventh switching element Q_{B1} may be always turned off.

When the voltage signal of the inverter side is in a negative half-cycle, drive signals of the second switching element Q_{A3}, the sixth switching element Q_{A4}, the seventh switching element Q_{B1} and the third switching element Q_{B2} may be PWM signals. The first switching element Q_{A2} and the fourth switching element Q_{B3} may be turned on as freewheeling tubes, the second switching element Q_{A3} and the sixth switching element Q_{A4} may be turned on in a complementary manner, the seventh switching element Q_{B1} and the third switching element Q_{B2} may be turned on in a complementary manner, the first switching element Q_{A2} and the fourth switching element Q_{B3} may be always turned on, and the fifth switching element Q_{A1} and the eighth switching element Q_{B4} may be always turned off.

It should be noted that, when the DC/AC circuit is in the grid-interconnection spilt-phase operating mode, waves in the grid-interconnection spilt-phase operating mode may be the same as those in the grid-off phase splitting operating mode. Therefore, details are not described again.

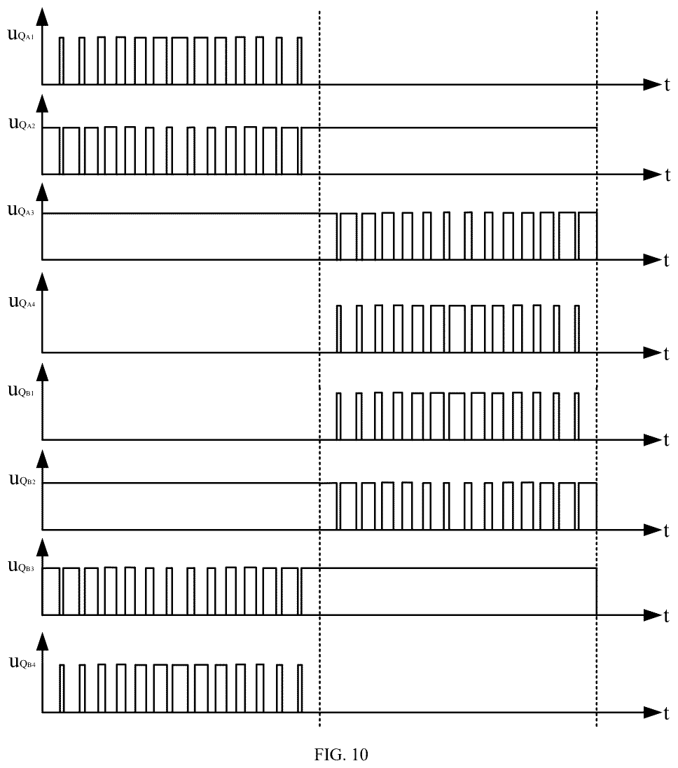

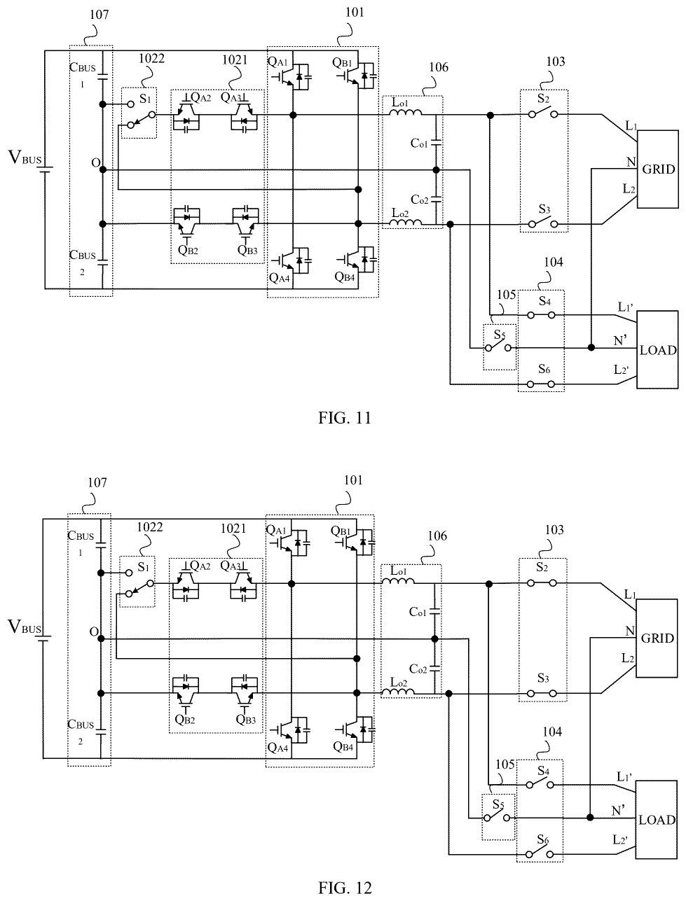

FIG. 11 is a schematic diagram of a state in which a DC/AC circuit in a grid-off single-phase operating mode in the first exemplary embodiment of the present disclosure. When a voltage difference between a positive DC bus voltage and a negative DC bus voltage is large, for example, 5V/10V or above, a DC bias may be introduced, so that the output voltage of the DC/AC circuit may be always offset in a certain direction, resulting in output overvoltage, which affects a normal operation of the DC/AC circuit. In the present embodiment, referring to FIG. 11, when the DC/AC circuit is in the grid-off single-phase operating mode, the first switching element Q_{A2} may be disconnected to the midpoint O between the positive and negative DC buses, and the output voltage of the DC/AC circuit may not be affected by the imbalance between the voltage of the positive DC bus and the voltage of the negative DC bus, so as to avoid a problem that an output voltage is offset to overvoltage.

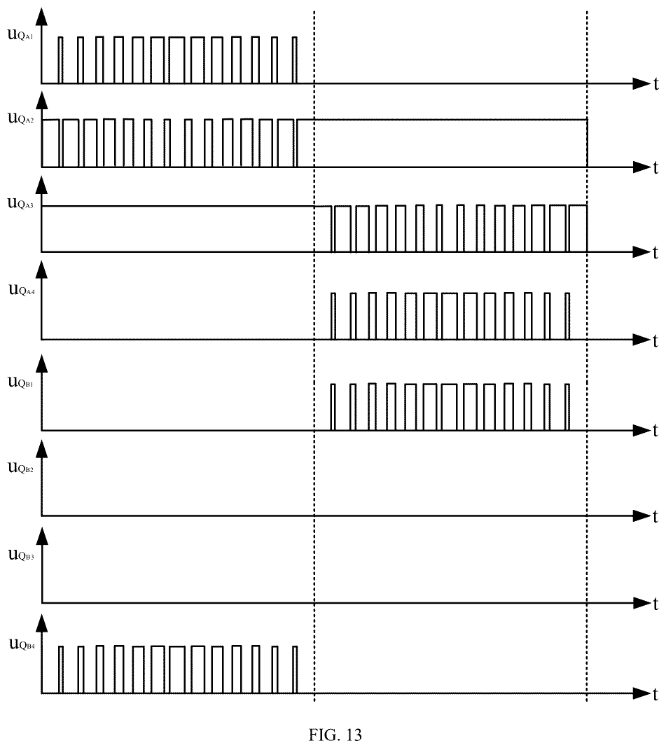

FIG. 12 is a schematic diagram of a state in which a DC/AC circuit in the grid-interconnection single-phase operating mode in the first exemplary embodiment of the present disclosure. FIG. 13 is a schematic diagram of a wave transmission time sequence of a switching element when a DC/AC circuit is in the grid-interconnection single-phase operating mode in the first exemplary embodiment of the present disclosure. When the DC/AC circuit is in the grid-interconnection single-phase operating mode, the fifth switching element Q_{A1}, the sixth switching element Q_{A4}, the seventh switching element Q_{B1}, and the eighth switching element Q_{B4} may be taken as main power switches, and the first switching element Q_{A2} and the second switching element Q_{A3} may be in operation as freewheeling tubes.

When a voltage signal of a grid side is in a positive half-cycle, drive signals of the fifth switching element Q_{A1}, the first switching element Q_{A2}, and the eighth switching element Q_{B4} may be PWM signals, the second switching element Q_{A3} may be turned on as freewheeling tubes, the first switching element Q_{A2} and the fifth switching element Q_{A1} may be turned on in a complementary manner, the drive signal of the fifth switching element Q_{A1} may be the same as that of the eighth switching element Q_{B4}, the second switching element Q_{A3} may be always turned on, and the sixth switching element Q_{A4} and the seventh switching element Q_{B1} may be always turned off. When the voltage signal of the grid side is in a negative half-cycle, drive signals of the second switching element Q_{A3}, the sixth switching element Q_{A4}, and the seventh switching element Q_{B1} may be PWM signals. The first switching element Q_{A2} may be turned on as a freewheeling tube, the second switching element Q_{A3} and the sixth switching element Q_{A4} may be turned on in a complementary manner, the drive signal of the sixth switching element Q_{A4} may be the same as that of the seventh switching element Q_{B1}, the first switching element Q_{A2} may be always turned on, and the fifth switching element Q_{A1} and the eighth switching element Q_{B4} may be always turned off.

When the DC/AC circuit is in the grid-interconnection single-phase operating mode, the first switching element Q_{A2} may be disconnected to the midpoint O between the positive and negative DC buses, and the output voltage of the DC/AC circuit may not be affected by the imbalance between the voltage of the positive DC bus and the voltage of the negative DC bus, so as to avoid the problem that the output voltage is offset to overvoltage.

It should be noted that when the DC/AC circuit is in the grid-off single-phase operating mode, waves in the grid-off single-phase operating mode may be the same as those in the grid-off single-phase operating mode. Therefore, details are not described again.

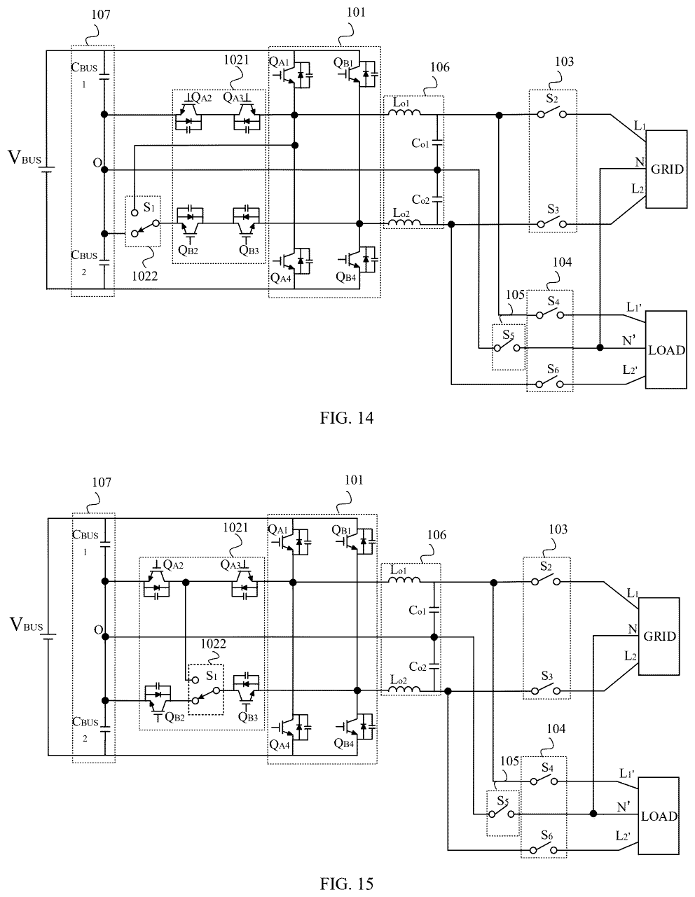

FIG. 14 is a schematic diagram of a circuit structure of a DC/AC circuit in a second exemplary embodiment of the present disclosure. A difference from the first exemplary embodiment lies in that the first switching terminal of the first switching unit 1022 may be connected to the midpoint O of the positive and negative DC buses, the second switching terminal of the first switching unit 1022 may be connected to the midpoint of the first bridge arm, and the fixed terminal of the first switching unit 1022 may be connected to the emitter (source) electrode of the third switching element Q_{B2}.

It should be noted that a control principle of the switching elements, the first switching unit 1022, the second switching unit 103, and the third switching unit 104 in the second exemplary embodiment may be basically the same as that in the first exemplary embodiment, and the same technical effect may be implemented. Therefore, details are not described again.

FIG. 15 is a schematic diagram of a circuit structure of a DC/AC circuit in a third exemplary embodiment of the present disclosure. A difference from the first example embodiment lies in that a first switching terminal of the first switching unit 1022 may be connected to the collector (drain) electrode of the third switching element Q_{B2}, the second switching terminal of the first switching unit 1022 may be connected to a midpoint between the first switching element Q_{A2} and the second switching element Q_{A3}, and the fixed terminal of the first switching unit 1022 may be connected to the collector (drain) electrode of the fourth switching element Q_{B3}.

It should be noted that a control principle of the switching elements, the first switching unit 1022, the second switching unit 103, and the third switching unit 104 in the third exemplary embodiment may be basically the same as that in the first example embodiment, and the same technical effect may be implemented. Therefore, details are not described again.

It may be understood that the first switching unit 102 may be further disposed between the first switching element Q_{A2} and the second switching element Q_{A3}, disposed between the midpoint of the first bridge arm and the freewheeling unit, or disposed between the midpoint of the second bridge arm and the freewheeling unit. Control principles of the switching elements, the first switching unit, the second switching unit, and the third switching unit in the DC/AC circuit may be basically the same as those in the third exemplary embodiment, and the same technical effect may be implemented. Therefore, details are not described again.

In an embodiment, an inverter device is provided in the present disclosure, including a control unit and the DC/AC circuit in any one of the foregoing embodiments. The control unit is configured to provide timing control of the first switching unit and the switching elements in the DC/AC circuit.

Furthermore, the control unit is further configured to control the second switching unit and the third switching unit.

In an embodiment, the control unit may include a controller, and the controller may include, for example, a DSP (Digital Signal Processor), a MCU (Micro Controller Unit), or the like.

It should be noted that the switching of the first switching unit, the second switching unit, and the third switching unit, and the timing control of the switching elements in the DC/AC circuit may be described in detail in the foregoing embodiments. Therefore, details are not described again in the present embodiment.

The various technical features of the above embodiments can be combined in any way. To make the description concise, not all possible combinations of the various technical features in the above embodiments have been described. However, as long as there is no contradiction in the combinations of these technical features, the combinations should be considered within the scope of the specification.

The above-described embodiments express only several embodiments of the present disclosure, which are described in a more specific and detailed manner, but are not to be construed as a limitation on the scope of the present disclosure. For the skill in the art, several deformations and improvements can be made without departing from the conception of the present disclosure, all of which fall within the scope of protection of the present disclosure. Therefore, the scope of protection of the present disclosure shall be subject to the attached claims.

What is claimed is:

1. A DC/AC circuit, comprising an inverter unit, a freewheeling unit, and a first switching unit, wherein
the inverter unit comprises a first bridge arm and a second bridge arm which are connected between positive and negative DC buses and configured to invert a direct current output by the positive and negative DC buses to an alternating current;
the freewheeling unit comprises a first freewheeling circuit connected between a midpoint of the first bridge arm and a midpoint of the positive and negative DC buses, and a second freewheeling circuit connected between a midpoint of the second bridge arm and the midpoint of the positive and negative DC buses; and
a fixed terminal and a first switching terminal of the first switching unit are connected in a branch at which one of the first freewheeling circuit and the second freewheeling circuit is located, and a second switching terminal of the first switching unit is connected to the other one of the first freewheeling circuit and the second freewheeling circuit to form a freewheeling loop.

2. The DC/AC circuit of claim 1, wherein when the fixed terminal of the first switching unit is in communication with the first switching terminal of the first switching unit, the DC/AC circuit outputs the alternating current in a phase splitting operating mode; and
when the fixed terminal of the first switching unit is in communication with the second switching terminal of the first switching unit, the DC/AC circuit outputs the alternating current in a single-phase operating mode.

3. The DC/AC circuit of claim 1, wherein the fixed terminal and the first switching terminal of the first switching unit are connected in series between the midpoint of the positive and negative DC buses and one of the first freewheeling circuit and the second freewheeling circuit, and the second switching terminal of the first switching unit is connected to the other one of the first freewheeling circuit and the second freewheeling circuit.

4. The DC/AC circuit of claim 1, wherein the first freewheeling circuit comprises at least two switching elements connected in series, and the second freewheeling circuit comprises at least two switching elements connected in series; and
the fixed terminal and the first switching terminal of the first switching unit are connected in series between two switching elements, which are in one of the first freewheeling circuit and the second freewheeling circuit, and the second switching terminal of the first switching unit is connected to a midpoint of two switching elements, which are in the other one of the first freewheeling circuit and the second freewheeling circuit.

5. The DC/AC circuit of claim 1, wherein the first freewheeling circuit comprises a first switching element and a second switching element connected in series, the second switching element is connected to the midpoint of the first bridge arm, the second freewheeling circuit comprises a third switching element and a fourth switching element connected in series, and the fourth switching element is connected to the midpoint of the second bridge arm.

6. The DC/AC circuit of claim 5, wherein the fixed terminal of the first switching unit is connected to the first switching element or the third switching element, and the first switching terminal of the first switching unit is connected to the midpoint of the positive and negative DC buses.

7. The DC/AC circuit of claim 5, wherein the fixed terminal of the first switching unit is connected to the fourth switching element, the first switching terminal of the first switching unit is connected to the third switching element, and the second switching terminal of the first switching unit is connected to a midpoint between the first switching element and the second switching element, or
the fixed terminal of the first switching unit is connected to the second switching element, the first switching terminal of the first switching unit is connected to the first switching element, and the second switching terminal of the first switching unit is connected to a midpoint between the third switching element and the fourth switching element.

8. The DC/AC circuit of claim 1, further comprising a second switching unit and a third switching unit which are connected to an output terminal of the inverter unit, wherein the second switching unit and the third switching unit are configured to control switch between grid interconnection and grid off.

9. The DC/AC circuit of claim 8, further comprising a fourth switching unit connected between the midpoint of the positive and negative DC buses and a null line terminal, wherein when the DC/AC circuit is in a phase splitting operating mode, the fourth switching unit is in a turn-on state, and when the DC/AC circuit is in a single-phase operating mode, the fourth switching unit is in a turn-off state.

10. The DC/AC circuit of claim 1, further comprising a first filter unit connected to an output terminal of the inverter unit, wherein the first filter unit is connected to the midpoint of the positive and negative DC buses.

11. The DC/AC circuit of claim 1, further comprising a second filter unit connected between the positive and negative DC buses, wherein the second filter unit comprises a third capacitor connected between the positive DC bus and the midpoint of the positive and negative DC buses, and a fourth capacitor connected between the negative DC bus and the midpoint of the positive and negative DC buses.

12. An inverter device, comprising a control unit and the DC/AC circuit of claim 1, wherein the control unit is configured to control the DC/AC circuit.

13. The inverter device of claim 12, wherein when the fixed terminal of the first switching unit is in communication with the first switching terminal of the first switching unit, the DC/AC circuit outputs the alternating current in a phase splitting operating mode; and
when the fixed terminal of the first switching unit is in communication with the second switching terminal of the first switching unit, the DC/AC circuit outputs the alternating current in a single-phase operating mode.

14. The inverter device of claim 12, wherein the fixed terminal and the first switching terminal of the first switching unit are connected in series between the midpoint of the positive and negative DC buses and one of the first freewheeling circuit and the second freewheeling circuit, and the second switching terminal of the first switching unit is connected to the other one of the first freewheeling circuit and the second freewheeling circuit.

15. The inverter device of claim 12, wherein the first freewheeling circuit comprises at least two switching elements connected in series, and the second freewheeling circuit comprises at least two switching elements connected in series; and
the fixed terminal and the first switching terminal of the first switching unit are connected in series between two switching elements, which are in one of the first freewheeling circuit and the second freewheeling circuit, and the second switching terminal of the first switching unit is connected to a midpoint of two switching elements, which are in the other one of the first freewheeling circuit and the second freewheeling circuit.

16. The inverter device of claim 12, wherein the first freewheeling circuit comprises a first switching element and a second switching element connected in series, the second switching element is connected to the midpoint of the first bridge arm, the second freewheeling circuit comprises a third switching element and a fourth switching element connected in series, and the fourth switching element is connected to the midpoint of the second bridge arm.

17. The inverter device of claim 16, wherein the fixed terminal of the first switching unit is connected to the first switching element or the third switching element, and the first switching terminal of the first switching unit is connected to the midpoint of the positive and negative DC buses.

18. The inverter device of claim 16, wherein the fixed terminal of the first switching unit is connected to the fourth switching element, the first switching terminal of the first switching unit is connected to the third switching element, and the second switching terminal of the first switching unit is connected to a midpoint between the first switching element and the second switching element, or
the fixed terminal of the first switching unit is connected to the second switching element, the first switching terminal of the first switching unit is connected to the first switching element, and the second switching terminal of the first switching unit is connected to a midpoint between the third switching element and the fourth switching element.

19. The inverter device of claim 12, further comprising a second switching unit and a third switching unit which are connected to an output terminal of the inverter unit, wherein the second switching unit and the third switching unit are configured to control switch between grid interconnection and grid off.

20. The inverter device of claim 19, further comprising a fourth switching unit connected between the midpoint of the positive and negative DC buses and a null line terminal, wherein when the DC/AC circuit is in a phase splitting operating mode, the fourth switching unit is in a turn-on state, and when the DC/AC circuit is in a single-phase operating mode, the fourth switching unit is in a turn-off state.
